(19) United States
(12) Patent Application Publication
(10) Pub. No.: US 2010/0112310 A1
(43) Pub. Date: May 6, 2010

(54) Substrate Patterning

(75) Inventors: Van Nguyen Truskett, Austin, TX (US); Gerard M. Schmid, Austin, TX (US); Michael N. Miller, Austin, TX (US); Douglas J. Resnick, Leander, TX (US); Benjamin G. Eynon, JR., Round Rock, TX (US); Byung-Jin Choi, Austin, TX (US); Kosta S. Selinidis, Austin, TX (US); Sidlgata V. Sreenivasan, Austin, TX (US); Nicholas A. Stacey, Austin, TX (US)

Correspondence Address: MOLECULAR IMPRINTS, PO BOX 81536, AUSTIN, TX, 78708-1536, US

(73) Assignee: Molecular Imprints, Inc., Austin, TX (US)

(21) Appl. No.: 12/607,547

(22) Filed: Oct. 28, 2009

Related U.S. Application Data
(60) Provisional application No. 61/109,519, filed on Oct. 30, 2008.

(51) Int. Cl. B32B 5/16; B44C 1/22

(52) U.S. Cl. 428/195.1; 216/11

(57) ABSTRACT

Systems and methods for providing identification patterns on substrates are described.

### CROSS REFERENCE TO RELATED APPLICATIONS

This application claims the priority to, and the benefit of, U.S. Provisional Application No. 61/109,519 filed Oct. 30, 2008, titled “Substrate Patterning,” the entire contents of which are incorporated herein by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a polymerizable layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of one embodiment of a lithographic system in accordance with the present invention.

FIG. 2 illustrates a simplified side view of the substrate shown in FIG. 1 having a patterned layer positioned thereon.

FIG. 3 illustrates simplified side views of formation of an exemplary patterned layer on substrate having multiple patterns using imprint lithography.

FIG. 4 illustrates simplified side views of formation of an exemplary patterned layer on substrate using imprint lithography.

FIG. 5 illustrates a simplified side view of the substrate and a fluid dispensing system.

FIG. 6 illustrates simplified side views of formation of an exemplary patterned layer on substrate.

FIG. 7 illustrates a process flow diagram implementing a method described in the present disclosure.

FIG. 8 illustrates a process flow diagram implementing a method described in the present disclosure.

FIG. 9 illustrates a process flow diagram implementing a method described in the present disclosure.

FIG. 10 illustrates simplified side views of an imprint lithography template that has been altered to provide identifying markings.

### DETAILED DESCRIPTION

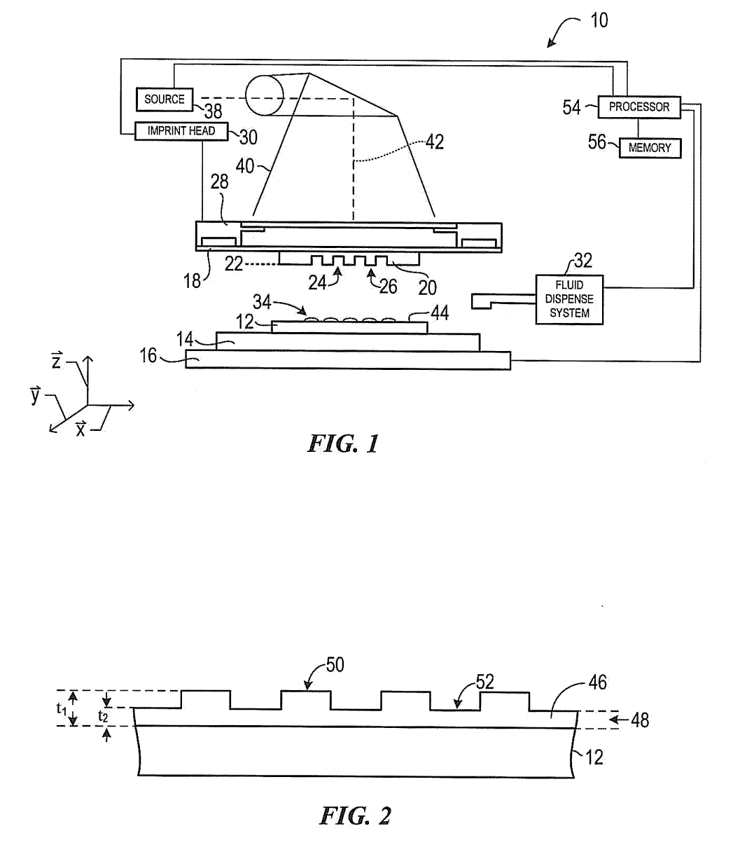

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 22 and substrate 12 depending on design considerations. Polymerizable material 34 may comprise a monomer as described in U.S. Pat. No. 7,157,036 and U.S. Patent Publication No. 2005/0187339, all of which are hereby incorporated by reference.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

Imprint lithography generally provides precision for replication of nanostructures from template 18; however, imprint lithography generally may be limited in creation of multiple, different patterns from template 18. The ability to create multiple, different patterns from template 18 may enable system 10 to provide descriptive marks (e.g., barcodes, numbers, or identification symbols). For example, descriptive marks may uniquely identify each substrate 12. Such unique identities may be further used to distinguish replicated templates from a single template replication tool.

Previous techniques for creating unique patterns on substrate 12 generally require additional hardware to define a pattern. For example, a beam of light or electrons may be used to selectively pattern substrate 12. These approaches are considered to be serial and/or sequential operations, and generally have limited patterning throughput.

Alternatively, a beam of light (e.g. a laser spot) may be used to directly pattern substrate 12 by ablating the surface thereof. This process may be performed at a quick rate; however, it generally requires special tooling and/or additional process steps. Ablation may also create particle debris and contamination of substrate 12.

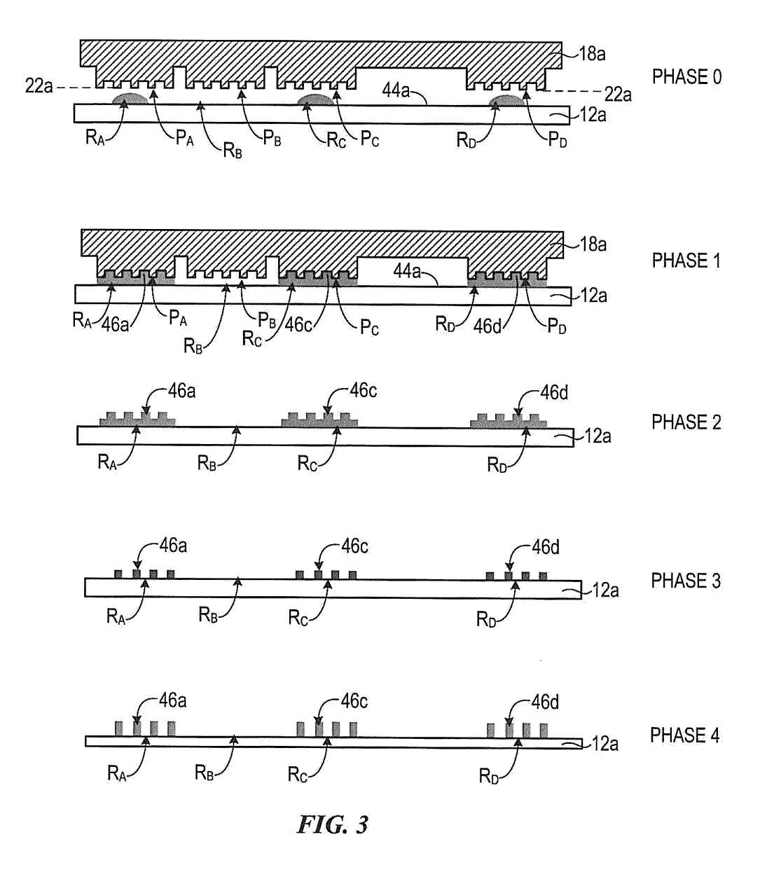

Referring to FIG. 3, illustrated therein are side views of template 18a during an imprint lithography process providing different patterns for identification of substrate 12a. Generally, multiple patterns may be defined on patterning surface 22a of template 18a. For example, patterns P_{A-D} may be defined on patterning surface 22a of template 18a as shown in Phase 0. Patterns P_{A-D} may correspond to a region R_{A-D} defined on substrate 12a. During Phase 0, polymerizable material 34 may be selectively deposited on substrate 12a in regions R_{A-D}. For example, polymerizable material 34 may be deposited on substrate 12a on region R_{A-D} that corresponds to pattern P_{A-D} on patterning surface 22a, or there may be no polymerizable material 34 deposited on specific regions on substrate 12. For example, as illustrated in FIG. 3, polymerizable material 34 may be deposited in regions R_{A}, R_{C}, and R_{D} corresponding to patterns P_{A}, P_{C}, and P_{D} on patterning surface 22a; however, in region R_{B}, no polymerizable material 34 may be deposited on substrate 12.

After the desired regions R_{A}, R_{C}, and R_{D} are filled with polymerizable material 34, template 18a may be lowered to substrate 12a such that template 18a is in contact with the polymerizable material 34, and source 38 produces energy 40 (shown in FIG. 1), e.g., broadband ultraviolet radiation, causing polymerizable material 34 to solidify and/or cross-link conforming to a shape of a surface 44a of substrate 12a and patterning surface 22a of template 18a, defining patterned layers 46a, 46c, and 46d on substrate 12a that correspond to patterns P_{A}, P_{C}, and P_{D}, as shown in Phase 1. The template 18a may then be removed (Phase 2) and patterned layers 46a, 46c, and 46d etched (e.g., descum etch) as shown in Phase 3. The patterned layers 46a, 46c, and 46d may then be further etched into substrate 12a (Phase 4).

Patterned layers 46a, 46c, and 46d may have distinct patterns and/or similar patterns. For example, patterned layers 46a, 46c, and 46d may have distinct patterns providing for a descriptive mark that uniquely identifies the substrate 12a. Additionally, the distinct pattern may be provided by the lack of patterned layers 46 on substrate 12a. For example, a distinct pattern may be formed by the non-use of pattern P_{B} providing a gap between patterned layer 46a and 46c. For example, a number, a symbol, or a binary number may be derived from the distinct patterns that are formed on the substrate.

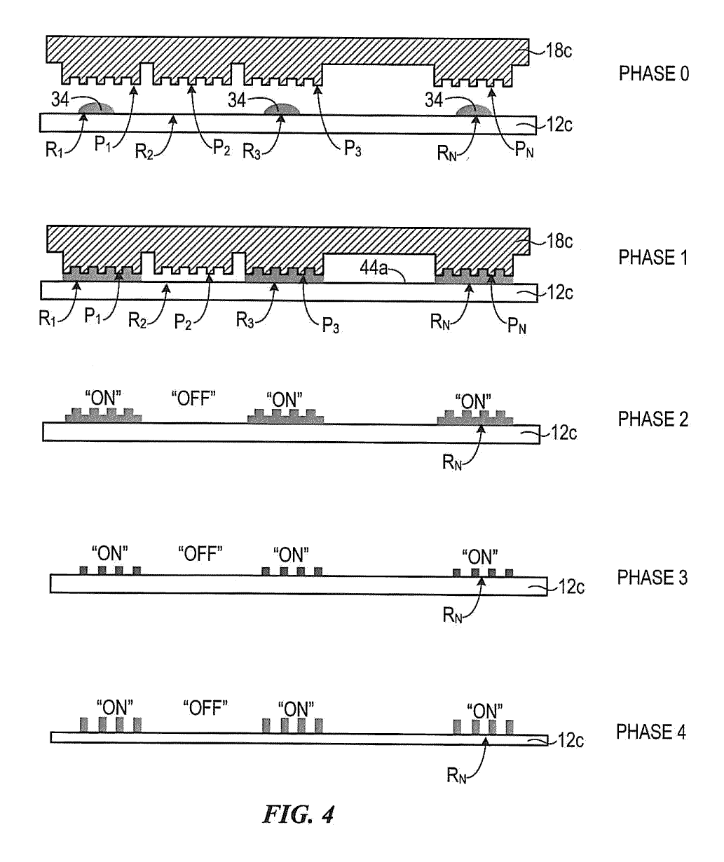

Referring to FIG. 4, template 18c may be fabricated with a number of patterns P_{1-N} designed with unique diffraction characteristics that may be identified by optical scanners. For example, patterns P_{1-N} may be grating or checkerboard patterns. Such patterns P_{1-N} may be arranged in an array on template 18c to facilitate optical scanning of patterns P_{1-N}. Each pattern P_{1-N} may form a number, symbol, or binary number. For example, each pattern may be assigned a bit value (e.g., 1, 2, 3 . . . N, wherein N equals the number of patterns in the array). During imprinting, each pattern P_{1-N} may be associated with region R_{1-N} of substrate 12c. Polymerizable material 34 may be selectively deposited or positioned on substrate 12c in regions R_{1-N}. If polymerizable material 34 is deposited within a region R, the associated pattern P may be designated as “on.” For example, if polymerizable material 34 is deposited in region R₃, the associated pattern P₃ may be designated as “on.” If polymerizable material 34 is not deposited within a region R, the associated pattern P may be designated as “off.” For example, if polymerizable material 34 is not deposited in region R₂, the associated pattern P₂ may be designated as “off.” It should be noted the region R₂ is flush with the substrate surface. Using pattern designations of “on” and “off,” patterns P_{1-N} may encode any binary number up to 2^{N}. For example, patterns P₁₋₃₀ may provide up to one billion distinct bar codes that may be patterned on substrate 12c.

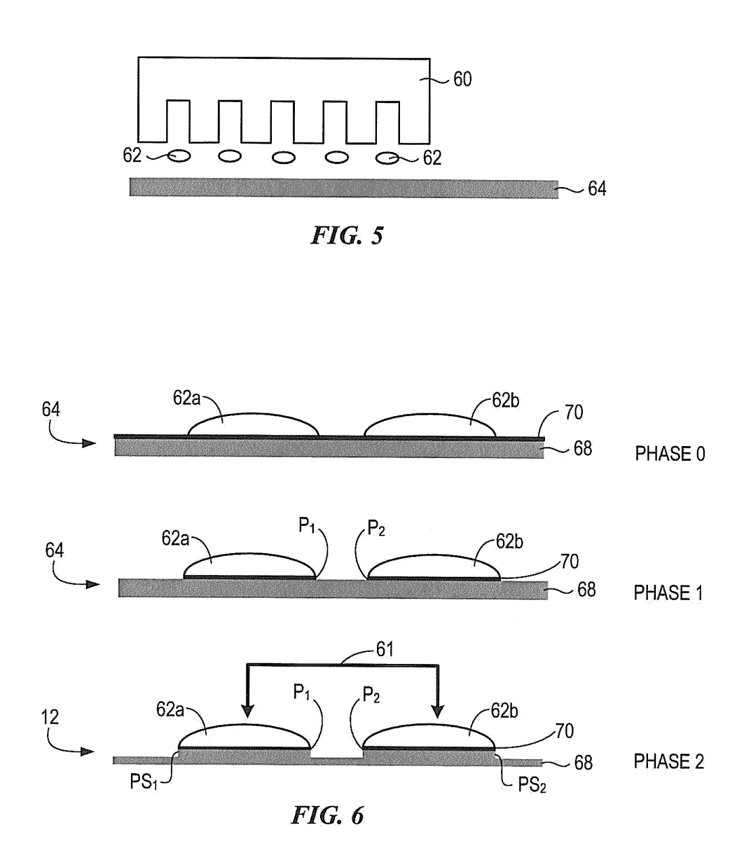

Referring to FIGS. 5-6, a drop deposition apparatus 60 may be used to dispense a resist pattern 61. Resist pattern 61 may be formed on substrate 12, a replica template (not shown), or a master template (not shown). For simplicity in description, the following describes formation of the resist pattern 61 on substrate 12.

Generally, the drop deposition device 60 may dispense fluid 62 on a multi-layer substrate 64. In an embodiment, multi-layer substrate 64 may comprise include chrome or quartz. The fluid 62 remains on multi-layer substrate 64 during an imprint process (as described above) and results in resist pattern 61 that may be readable by a user's eye and/or machine application. Resist pattern 61 may be any original pattern that may be used for identification of substrate 12. For example, the original pattern may be a number, symbol, or binary number.

Exemplary drop deposition devices 60 may include, but are not limited to, piezo inkjets, MEMs base printheads, and the like. Fluid 62 may be any fluid that provides resist pattern 61 readable by user's eye and/or machine application. Generally, fluid 62 remains on multi-layer substrate 64 during etching. For example, fluid 62 is generally not removable during chrome and/or quartz etching. One example of fluid 62 may be JetStream ink manufactured by Sunjet a corporation located in Amelia, Ohio,

FIG. 6 illustrates simplified side views of an exemplary formation of substrate 12. Substrate 12 is generally formed from multi-layer substrate 64 (Phase 0) having fluid 62 dispensed on thereon. The resulting substrate 12 (see Phase 2) comprises resist pattern 61.

Multi-layer substrate 64 may comprise a substrate layer 68 and a hard mask layer 70. Substrate layer 68 may be formed of materials including, but not limited to, fused-silica, quartz, silicon, organic polymers, siloxane polymers, borosilicate glass, fluorocarbon polymers, metal, hardened sapphire, and/or the like. Hard mask layer 70 may be formed from materials including, but not limited to, tantalum, tantalum nitride, tungsten, silicon carbide, amorphous silicon, chromium, chromium nitride, molybdenum, molybdenum silicide, titanium, titanium nitride, and/or the like. For example, hard mask layer 70 may be a chrome film of approximately 160 angstroms.

Generally, fluid 62 remains on multi-layer substrate 64 during the imprint process. In lithography Phase 1, fluid 62 may substantially shield a portion P of hard mask layer 70 during hard mask layer etching (e.g. chrome etching). For example, as illustrated in FIG. 6, portions P₁ and P₂ of hard mask layer 70 may be substantially shielded by fluid drops 62a and 62b during substrate etching (e.g. quartz etching). In lithography Phase 2, fluid 62 may substantially shield a portion Pₛ of substrate layer 68 as well as portion P of hard mark layer 70. For example, as illustrated in Phase 2, portions P₁ and Ps₁ may be substantially shielded by fluid drop 62a and portions P₂ and Ps₂ may be substantially shielded by fluid drop 62b. The resulting substrate 12 comprises resist pattern 61.

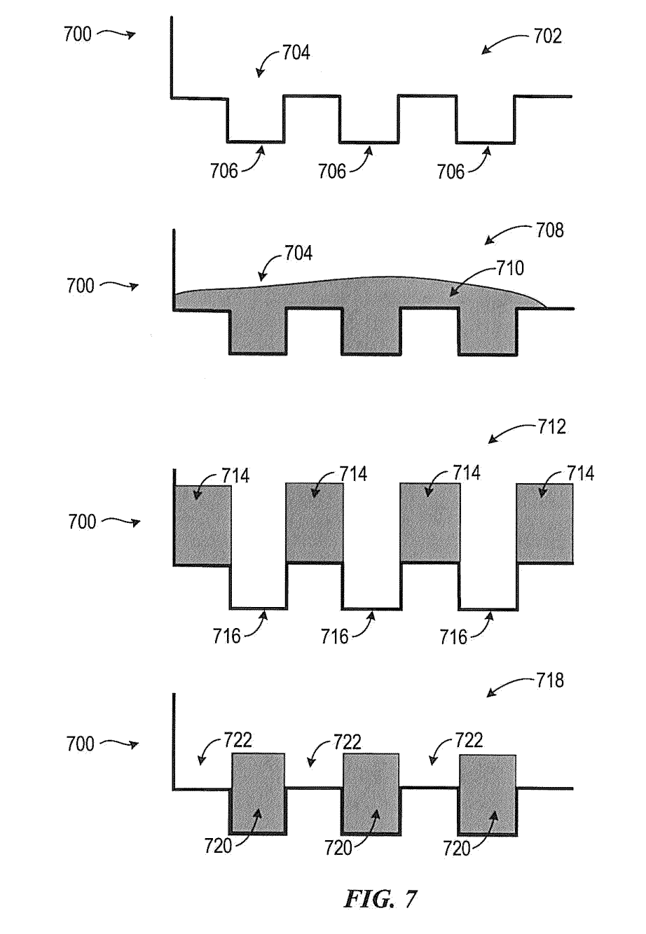

FIG. 7 illustrates examples of regions 700 within a substrate that have localized portions that have a different index of refraction than other regions in the substrate. The regions that have altered index of refractions may be used to identify the substrate in which they reside. For example, a number, a symbol, or a binary number may be derived from the relative positions of the altered and unaltered regions.

Region 702 is a region within a substrate, such as an imprint lithography template, that includes protruding portions 706 and the region is comprised of a first index of refraction 704. Region 702 may be considered an unaltered region. In one embodiment, region 708 includes a localized portion 710 that has been altered to be comprised of a second index of refraction. The second index of refraction may be lower or higher than the first index of refraction. The altered portion 710 may be created by focused laser beams that locally alter the index of refraction within a substrate by changing the density of the material at the intersection of the focused laser beams. Region 712 is another embodiment of a region that contains different indexes of refraction. For example, portions 714 have a different index of refraction than portions 716. As shown in FIG. 7, the altered portions 714 are confined to a plurality of localized portions beneath the non-protruding portions of region 712. In yet another embodiment, region 718 includes two portions with different indexes of refraction, 720 and 722. As shown in FIG. 7, the altered portions 720 are included in a localized region that includes the protruding portions of region 718 and the altered portion 720 may extend into the substrate in the area directly below the protruding portion. Portion 722 is the unaltered portion for region 718.

Exemplary Methods

Specifics of exemplary methods are described below. However, it should be understood that certain acts need not be performed in the order described, and may be modified, and/or may be omitted entirely, depending on the circumstances.

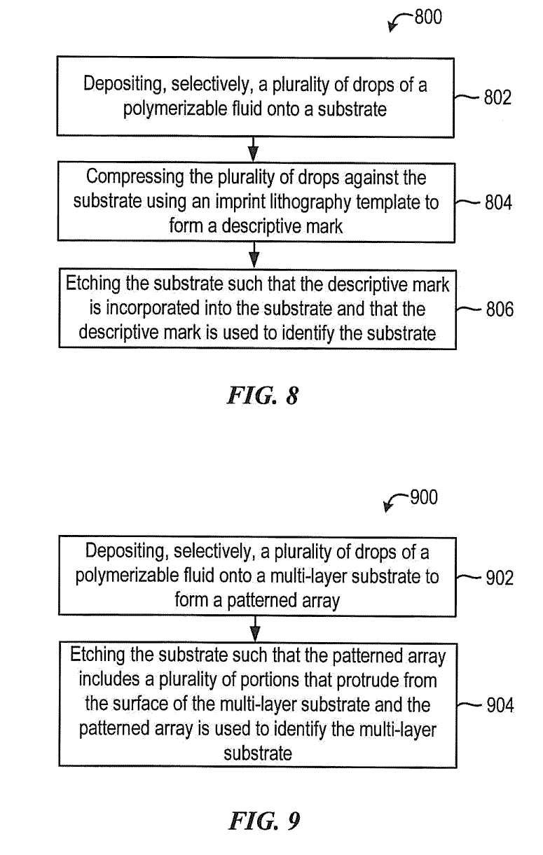

FIG. 8 illustrates an exemplary method 800 for creating descriptive marks on a substrate that are used to identify the individual substrate. The embodiment described in FIG. 4 will be used to explain the exemplary method described in FIG. 8.

At 802, a plurality of drops of a polymerizable fluid 34 is selectively deposited onto selected regions R₁, R₂, R_{N} of the substrate 12c. The arrangement of the drops will set the location of the protruding portions of a descriptive mark that will be used to identify the substrate. The drops will be selectively deposited in various orientations where each orientation may be considered a distinct descriptive mark for identification purposes. For example, each orientation or position of the protruding portions on the substrate may represent a different number, symbol, or binary number as described above in regards to FIG. 4.

At 804, the plurality of drops of a polymerizable fluid 34 are compressed against the substrate 12c using an imprint lithography template 18c such that a pattern P₁ is formed on drop R₁ as shown in FIG. 4. The pattern may be a checkerboard pattern, a grating pattern, or any other pattern that results in a protruding surface from the drop R₁. The plurality of drops R₁, R₃, R_{N}, will together form a descriptive mark.

At 806, the substrate is etched such that the descriptive mark is incorporated into the substrate and the descriptive mark may be used to identify the substrate. The descriptive mark may include portions which protrude from the substrate. The portions that protrude, such as R_{N} in phase 4 in FIG. 4, are assigned a first value, the portions that are flush with the substrate surface, such as R₂ in phase 0 of FIG. 4, are given a second value. The relative positions of the protruding portions and the non-protruding portions within the descriptive mark (R₁, R₂, R₃, and R_{N}) may be used to form a number, a symbol, or to encode a binary number. For the binary number embodiment, the protruding portions are assigned a first value, either “ON” or “1”, and the non-protruding portions are assigned a second value, either “OFF” or “0.” Alternatively, the protruding portions may be assigned a value of “OFF” or “0” and the non-protruding portions may be assigned a value of “ON” or “1.” Varying the positions of the protruding and non-protruding portions within the descriptive mark will allow the descriptive mark to represent a variety of binary numbers.

FIG. 9 illustrates an exemplary method 900 for creating descriptive marks on a substrate that are used to identify the individual substrate. The embodiment described in FIGS. 5 and 6 will be used to explain the exemplary method described in FIG. 9.

At 902, a plurality of drops of polymerizable fluid 62 is selectively deposited onto a multi-layer substrate 64 to form a patterned array 61. In one embodiment, the multi-layer substrate will include a hard mask layer 70 and a substrate layer 68. The selective deposition of the drops 62 will form a patterned array 61. The selective deposition of the drops 62 may vary the number of the drops deposited.

At 904, the multi-layer substrate 64 is etched such that the plurality of drops of polymerizable fluid 62 are used as a mask in the etch process, such that the portion of the substrate underneath a drop is not etched away. For example, the portions of the substrate under each drop will protrude from the surface of the substrate, see phase 2 FIG. 6. The pattern of protruding portions 61, or the patterned array, may be used to identify the multi-layer substrate. For example, the patterned array 61 may form a recognizable number or mark that is readable by a human eye or by an optical scanner. Additionally, in another embodiment, the patterned array may form a series of protruding portions that may be used to form a descriptive mark, a symbol, or encode binary numbers based on the relative positions of the protruding portions to each other.

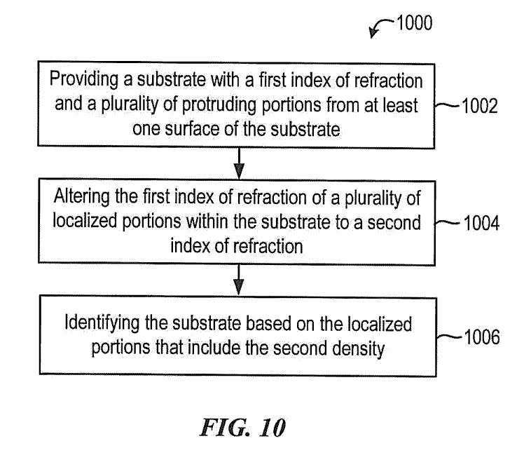

FIG. 10 illustrates an exemplary method 1000 for creating descriptive marks on a substrate that are used to identify the individual substrate. The embodiment described in FIG. 7 will be used to explain the exemplary method described in FIG. 10.

At 1002, a substrate with a plurality of regions, similar to region 702, is provided. In one embodiment, the first index of refraction 704 of the substrate is uniform within and around the protruding portions 706. In one embodiment, the substrate may be an imprint lithography template.

At 1004, a plurality of localized portions within the region 708 is altered to include a second index of refraction. In one embodiment, a region 708 includes altered localized portions 710 which may include several protruding and non-protruding portions of the substrate. In another embodiment, the region 712 includes altered localized portions 714 which may only include non-protruding portions of the region 712 and portions 716 that are still unaltered, such that they are comprised of the first index of refraction 704. In yet another embodiment, the region 718 includes altered portions 720, which may include portions of the protruding portions and non-protruding portions, and other portions 722 which may still be comprised of the first index of refraction.

At 1006, the substrate comprised of altered and non-altered regions may be identified based on the orientation of the altered regions, such as region 708, to each other or with respect to the other regions within the substrate that were not altered, like region 702. For example a number, a human readable character, a reference mark, an alignment target, a bar code, a binary number and the like may be derived from the relative positions of the altered and unaltered regions within the substrate. In one embodiment, identification of the substrate may occur by comparing the relative position of an altered region 708 to other altered and unaltered regions (not shown) on the substrate to form a number, a symbol, or a binary number that is used to identify the substrate. For example, the altered regions are assigned a value of “1” or “ON” and the unaltered regions are assigned a value of “0” or “OFF” to be used to determine a binary number that identifies the substrate. In an alternative embodiment, the altered regions may be assigned a value of “0” or “ON” and the unaltered regions may be assigned a value of “1” or “ON.” As described above for FIG. 4, the different index of refraction regions or different values may be used to form a descriptive mark, symbol, or encode binary number based on the relative positions of the altered and non-altered regions within the substrate. In another embodiment, identification of the substrate may occur by comparing the relative positions of altered regions, similar to regions 708 or 712, to other altered and unaltered regions (not shown) on the substrate to determine a descriptive mark, symbol, or encode a binary number that identifies the substrate.

Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims.

1. A method comprising:
selectively depositing a plurality of drops of a polymerizable fluid onto a substrate;
solidifying the polymerizable fluid; and,
etching the polymerizable fluid and portions of the substrate such that a descriptive mark is incorporated into the substrate, the descriptive mark configured to identify the substrate.

2. The method of claim 1, further comprising:
contacting the plurality of drops with an imprint lithography template, the template having an identification patterned array adapted to form a descriptive pattern on a surface of the substrate, the descriptive pattern providing a template for the descriptive mark.

3. The method of claim 1, wherein the descriptive mark is a human readable mark or a machine readable mark.

4. The method of claim 1, wherein the descriptive mark is selected from a group consisting of a number, a human readable character, a reference mark, an alignment target, a bar code, or a binary number.

5. The method of claim 1, wherein the descriptive mark includes a plurality of portions that are protruding from the surface of the substrate and a plurality of portions that are flush with the substrate surface, each protruding portion assigned a first value and each substrate surface portion assigned a second value.

6. The method of claim 5, wherein identifying the substrate is based upon an orientation of the protruding portions relative to the substrate surface portions, such that the orientation defining the descriptive mark using the first value of the protruding portions and the second value of the substrate surface portions.

7. The method of claim 6, wherein selectively depositing allows orientation of the plurality of portions that are protruding from the surface of the substrate and the plurality of portions that are flush with the substrate to be varied, such that the varied orientations each represent a unique descriptive mark.

8. The method of claim 1, wherein the selective depositing of the plurality of drops are arranged in an array such that portions of the substrate that are covered by the plurality of drops are assigned a first value and that portions of the substrate that are not covered by the plurality of drops are assigned a second value.

9. The method of claim 1, wherein the selective deposition of the drops occurs only in an area that is be patterned.

10. The method of claim 1, wherein the substrate is a multi-layered substrate.

11. The method of claim 10, wherein the selective depositing of the plurality of drops are varied in number and orientation on the multi-layered substrate.

12. The method of claim 1, further comprising merging the drops of polymerizable fluid to form a descriptive pattern, the descriptive pattern providing a template for the descriptive mark.

13. The method of claim 2, wherein only a portion of the identification pattern array is transferred to the surface of the substrate.

14. The method of claim 13, wherein drops of polymerizable fluid are dispensed only in superimposition with the portion of the identification pattern array.

15. The method of claim 10, wherein the multi-layer substrate is an imprint lithography template.

16. A substrate comprising:
an identification pattern array on a surface of the substrate, the identification pattern array configured to imprint a descriptive mark on a second substrate, the descriptive mark configured to identify the second substrate and selected from a group consisting of a number, a human readable character, a reference mark, an alignment target, a bar code, or a binary number.

17. The imprint lithography template of claim 16, wherein the descriptive mark is formed by an imprint lithography tool.

18. A template comprising:
a patterned array on a surface of the template configured to imprint a feature pattern on a substrate; and,
an identification pattern array on the surface of the template, the identification pattern array configured to identify a substrate, the descriptive mark including a first portion with a first index of refraction and a second portion with a second index of refraction.

19. The template of claim 18, wherein the descriptive mark is a human readable mark or a machine readable mark.

20. The template of claim 18, wherein the descriptive mark is selected from a group consisting of a number, a human readable character, a reference mark, an alignment target, a bar code, or a binary number.
